(19) United States
(12) Patent Application Publication
(10) Pub. No.: US 2024/0346174 A1
(43) Pub. Date: Oct. 17, 2024

(54) SELECTIVE OBFUSCATION OF LIVE RESOURCES IN A METAVERSE ENVIRONMENT

(71) Applicant: Kyndryl, Inc., New York, NY (US)

(72) Inventor: Cesar Bravo, Alajuela (CR)

(21) Appl. No.: 18/134,157

(22) Filed: Apr. 13, 2023

(51) Int. Cl. G06F 21/62

(52) U.S. Cl. CPC G06F 21/6245

(57) ABSTRACT

A computer-implemented method, according to one embodiment, includes gathering sharing policies associated with a first user sharing a live resource in a metaverse, and determining characteristics of a second user in the metaverse. The method further includes determining, based on the sharing policies and the characteristics of the second user, whether the second user is authorized to view the live resource shared by the first user. In response to a determination that the second user is not authorized to view the live resource, a first predetermined obfuscation condition is caused to be applied to the second user's view of the live resource for protecting the first user's privacy. Furthermore, in response to a determination that the second user is authorized to view the live resource, the second user is allowed to view the live resource.

### BACKGROUND

The present invention relates to the metaverse, and more specifically, this invention relates to selective obfuscation of live resources in a metaverse environment.

Virtual reality (VR) is a three-dimensional computer-generated user experience that a user can use a user device to experience and/or explore. These user devices may include, e.g., a VR headset, an augmented reality (AR) headset, VR glasses, VR rooms that include a plurality of display walls, etc. The metaverse is one example of a VR based environment that users explore, and typically includes avatars that are associated with and controlled by users who are virtually present in the metaverse via their use of user devices. This way, users are able to interact with other users, e.g., communicate, observe, present live resources, etc.

### SUMMARY

A computer-implemented method, according to one embodiment, includes gathering sharing policies associated with a first user sharing a live resource in a metaverse, and determining characteristics of a second user in the metaverse. The method further includes determining, based on the sharing policies and the characteristics of the second user, whether the second user is authorized to view the live resource shared by the first user. In response to a determination that the second user is not authorized to view the live resource, a first predetermined obfuscation condition is caused to be applied to the second user's view of the live resource for protecting the first user's privacy. Furthermore, in response to a determination that the second user is authorized to view the live resource, the second user is allowed to view the live resource.

A computer program product, according to another embodiment, includes a computer readable storage medium having program instructions embodied therewith. The program instructions are executable by a computer to cause the computer to perform the foregoing method.

A system, according to another embodiment, includes a hardware processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a flowchart of a method, in accordance with one embodiment of the present invention.

FIG. 4 is a flowchart of a method, in accordance with one embodiment of the present invention.

FIG. 5 is a flowchart of a method, in accordance with one embodiment of the present invention.

FIGS. 6A-6C are representations of a metaverse environment, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for selective obfuscation of live resources in a metaverse environment.

In one general embodiment, a computer-implemented method includes gathering sharing policies associated with a first user sharing a live resource in a metaverse, and determining characteristics of a second user in the metaverse. The method further includes determining, based on the sharing policies and the characteristics of the second user, whether the second user is authorized to view the live resource shared by the first user. In response to a determination that the second user is not authorized to view the live resource, a first predetermined obfuscation condition is caused to be applied to the second user's view of the live resource for protecting the first user's privacy. Furthermore, in response to a determination that the second user is authorized to view the live resource, the second user is allowed to view the live resource.

In another general embodiment, a computer program product includes a computer readable storage medium having program instructions embodied therewith. The program instructions are executable by a computer to cause the computer to perform the foregoing method.

In another general embodiment, a system includes a hardware processor, and logic integrated with the processor, executable by the processor, or integrated with and executable by the processor. The logic is configured to perform the foregoing method.

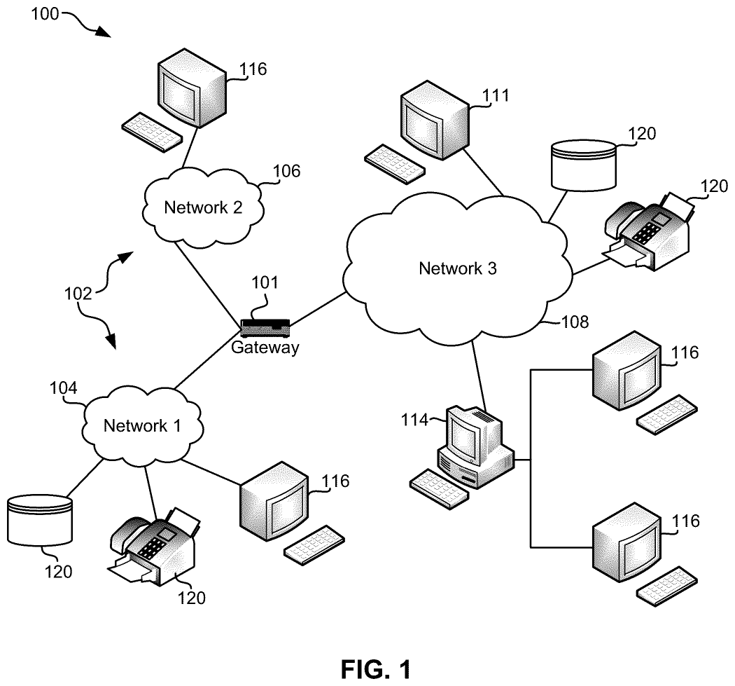

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

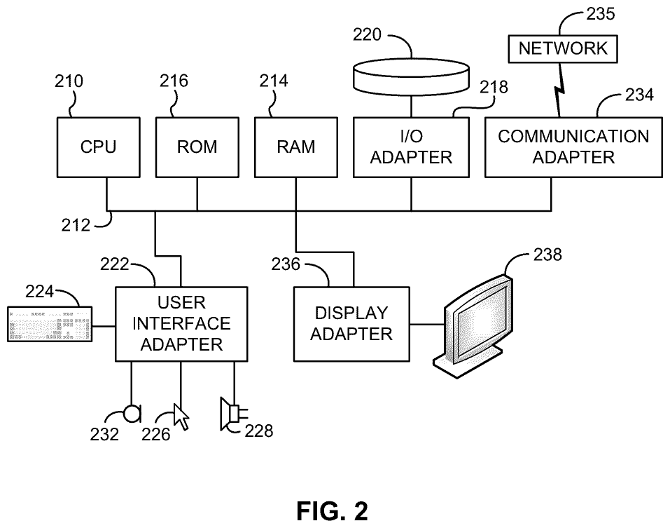

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using extensible Markup Language (XML), C, and/or C++ language, or other programming languages, along with an object-oriented programming methodology. Object-oriented programming (OOP), which has become increasingly used to develop complex applications, may be used.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As mentioned elsewhere above, virtual reality (VR) is a three-dimensional computer-generated user experience that a user can use a user device to experience and/or explore. These user devices may include, e.g., a VR headset, an augmented reality (AR) headset, VR glasses, VR rooms that include a plurality of display walls, etc. The metaverse is one example of a VR based environment that users explore, and typically includes avatars that are associated with and controlled by users who are virtually present in the metaverse via their use of user devices. This way, users are able to interact with other users, e.g., communicate, observe, present live resources, etc.

Within shared virtual environments such as the metaverse, user privacy is often relatively valued by users interacting within the metaverse. Privacy within the metaverse may be limited in some deployments in that a user's live resources, e.g., such as virtual display screens, working on virtual computers, virtually writing notes, etc., are often observable to other users, e.g., eavesdropping other users, residing in a proximity of the user. For example, current metaverses are “open” worlds in which the content of a first user can also be seen by other users of the metaverse. This represents a privacy challenge because as a result of the first user sharing their desktop or camera, all users of the metaverse are able to see that virtual resource. For this reason, some users are relatively uncomfortable within a metaverse, as their personal and/or work information may be accessed by other users of the metaverse. In some cases, eavesdropping users may even attempt to maliciously exploit personal information of other users. A relatively significant amount of computer processing and financial costs are expended in recovering from successful unauthorized eavesdropping events, e.g., troubleshooting, implementing security measures, data recovery, etc. Accordingly, there is a need within the field of VR and particularly the metaverse to ensure that live resources of a user in a metaverse are obfuscated from other unauthorized users in the metaverse.

In sharp contrast to the deficiencies described above, and in order to mitigate the metaverse privacy concerns mentioned above, embodiments and approaches described herein include object-based visualization techniques in which all resources shared by a user can only be seen by authorized users or groups. For example, in some approaches, only people with a given set of characteristics are allowed to see a given virtual shared resource, e.g., a camera feed, share screen, etc. In another example, only selected users are allowed to see such a virtual shared resource. In yet another example, one or more users may be excluded from seeing a given virtual shared resource.

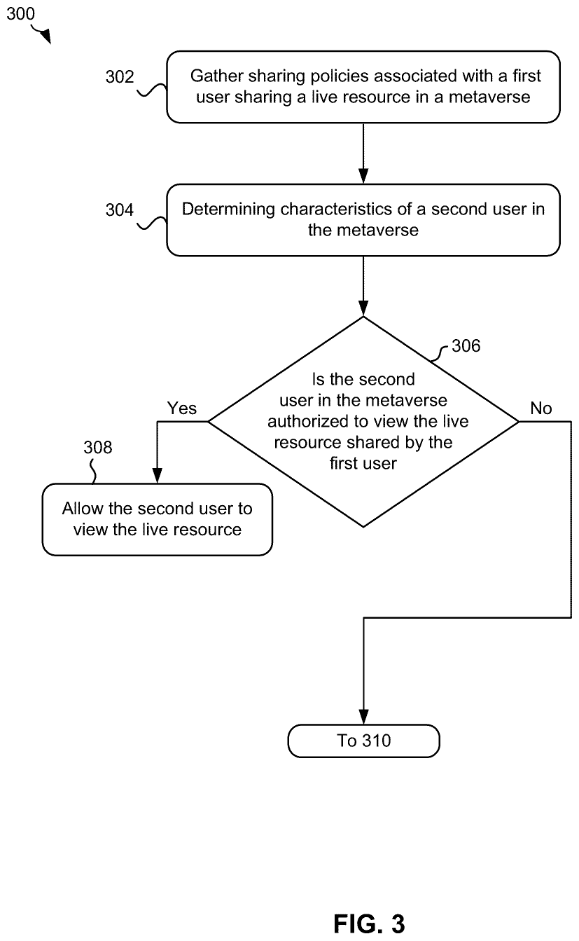

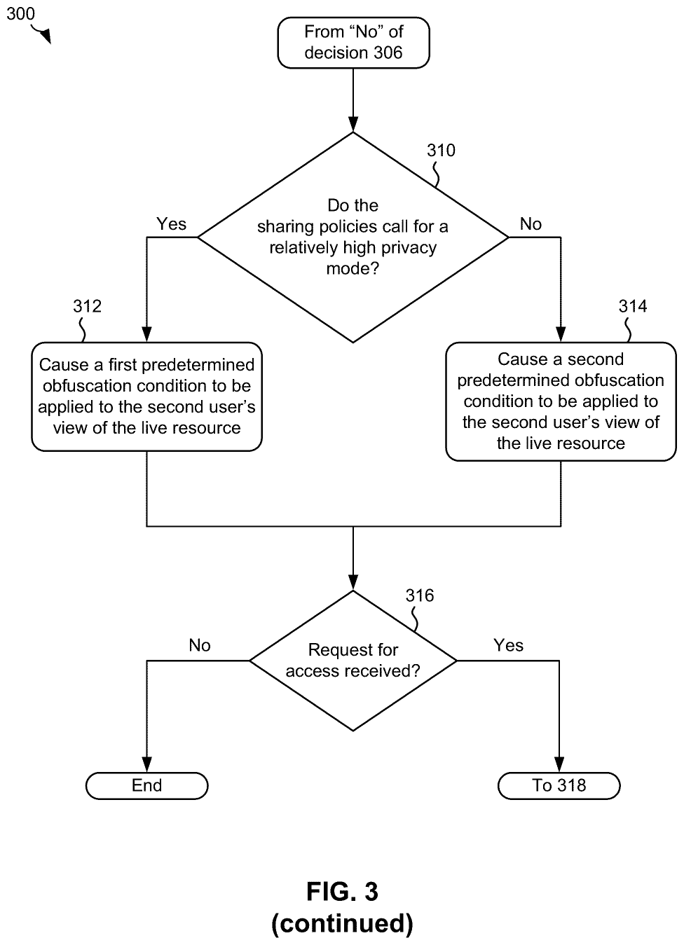

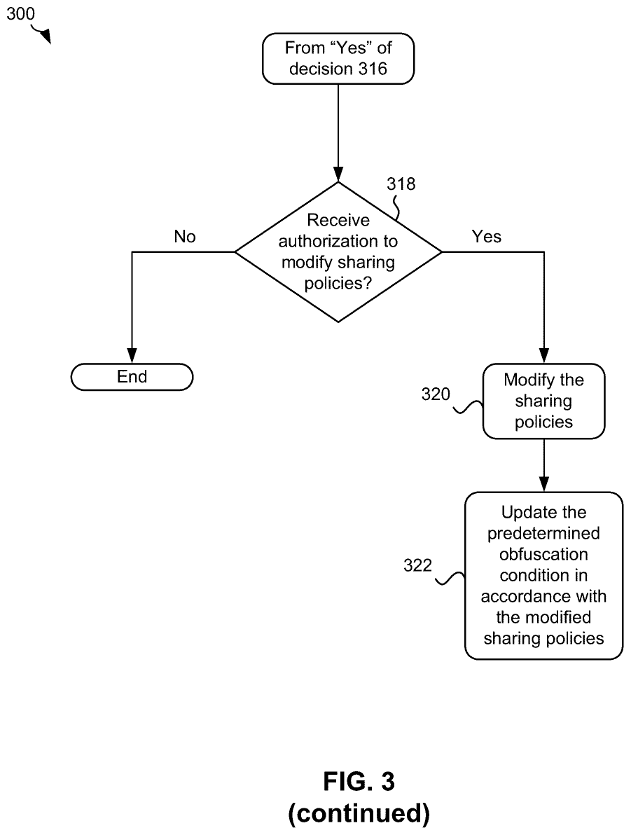

Now referring to FIG. 3, a flowchart of a method 300 is shown, according to one embodiment. The method 300 may be performed in accordance with the present invention in any of the environments depicted in any of the other FIGS., among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Method 300 may be performed using a computerized system, as the method 300 cannot practically be performed by a human, given the complexities of the calculations and sheer amount of data that is processed. Moreover, any attempt by a human to perform such method 300 would be expected to be rife with errors, again given the complexities of the calculations and sheer amount of data that is processed.

It may be prefaced that operations of method 300 are described with respect to a metaverse. Users of the metaverse may use user devices to explore the metaverse and interact with one another. For example, in some approaches, avatars that are each associated with a different one of the users may exist in the metaverse and may be caused to illustrate actual behavior of the users, e.g., voice, movement, facial expressions, etc. Furthermore, at least some users of the metaverse may present and/or share “live resources” within the metaverse. For context, a user's live resources may include, e.g., virtual display screens, working on virtual computers, virtually writing notes, etc., that are observable to other users. The live resource may additionally and/or alternatively include a camera feed, a shared screen, an audio feed paired with a visual display, etc. In some approaches, the live resource is configured to be interacted with by an avatar associated with at least the first user that exists in the metaverse. In one approach, the live resource responds to an avatar touch and/or voice input that is controlled by users (associated with the avatars) using user device(s). For example, a virtual display screen may be navigated during a presentation by an avatar associated with a first user, and one or more users having avatars within a predetermined proximity of the presenting first user may be able to view the presentation. Various operations described use sharing policies of a user to selectively limit an extent that other users within the metaverse are able to have access to such live resources.

Operation 302 includes gathering sharing policies associated with a first user sharing a live resource in a metaverse. For context, sharing policies mentioned herein may, in some approaches, be set and/or dynamically adjusted by users associated with the sharing policies. Furthermore, the sharing policies of the first user may, in some approaches, specify characteristics of other users that are allowed to access live resources of the first users and/or characteristics of other users that are not allowed to access live resources of the first users. A non-limiting illustrative list of such characteristics includes, e.g., a degree of mutual connections that the other user has with the first user, an amount of time that the user has spent in the metaverse, past geographical locations within the metaverse that the user has visited, credentials that the other user holds, security measures that the first user requires for other user devices to use in order to be authorized access to the first user's live resources, a list of blocked users that are not allowed access to the first user's live resources, etc. It may be noted that using the amount of time that the user has spent in the metaverse as a characteristic prevents bot accounts from being created to send spamming requests for accessing live resources which would otherwise deteriorate performance of a system deploying the metaverse. In some other approaches, the characteristics may additionally and/or alternatively specify whether one or more privacy modes, that may be dynamically adjusted based on a subject matter of the content of the first user's live resources, are enabled. For example, in some approaches, in response to receiving an indication from the first user and/or in response to a determination that the first user's live resources include, e.g., banking information, personal details, records, etc., a relatively “high privacy mode” may be set for the first user's live resources. In some other approaches, the relatively high privacy mode may be set by the first user. In contrast, in response to receiving an indication from the first user and/or in response to a determination that the first user's live resources include, e.g., public information, non-personal details, etc., a relatively “low privacy mode” may be set for the first user's live resources. In yet another approach, the relatively high privacy mode may be enabled as a service that is offered to users, e.g., for a fee, while a relatively lesser degree of privacy mode may be a default degree of security offered to users. Application of such privacy modes will be described in greater detail elsewhere below, e.g., see operation 312.

It should be noted that, in embodiments and approaches described herein, any parameters and/or use of user data, e.g., see operation 302, is preferably only determined and used subsequent to a user granting permission for their data to be considered. More specifically, this permission is preferably obtained in such a way that the user has the opportunity to consider and review details of how their information will be used (to assist the user in making an informed decision), and thereafter presented with an option to opt-in, e.g., an expressly performed opt-in selection. Thereafter, the user is preferably reminded of their opt-in, and ongoingly presented with features, e.g., output for display on a user device associated with the user, that relatively easily allows the user to retract their previous election to opt-in. Note that these features may be presented to the user in any one or more formats, e.g., audibly, visually, braille, in multiple languages, etc. For example, the user may be presented with an unambiguous opt-out selection feature which, if elected by the user, terminates collection and use of data associated with the user, erases previously used data associated with the user, and notifies the user of the course of action taken to respect the user's selection of the opt-out feature. In the event that the user does not want to have their data used in one or more of the operations described herein, this decision is respected, and the user is preferably not again presented with such an option unless the user thereafter requests to reconsider the opt-in feature, e.g., based on a change in their decision.

Operation 304 includes determining characteristics of at least a second user in the metaverse. In some approaches, characteristics may be determined for users, e.g., such as the second user, in response to a determination that such users are within a predetermined degree of geographical proximity to the first user within the metaverse. For example, the predetermined degree of geographical proximity to the first user may be based on a geographical proximity that a user would be able to navigate to reach the first user within an amount of time that the first user is sharing the live resources, and thereby potentially view and/or eavesdrop on the live resources. In some approaches, an amount of time that the first user is sharing the live resources may be unable to be determined. Accordingly, a predetermined geographical proximity may be caused, e.g., instructed, to be established around the first user, and in response to a determination that a second user has entered the predetermined geographical proximity, a predetermined evaluation may be performed to determine whether the second user is authorized to view the live resources of the first user. In some approaches, the predetermined geographical proximity may be one that allows an amount of processing to determine and enforce viewing authorizations to be performed before the second user comes within a viewing or listening distance of the first user's live resources, e.g., based on an average walking or running speed of users. This ensures that the second user is not able to access the first user's live resources before a determination is made whether the second user is authorized to access such live resources.

For context, the characteristics of the second user may be determined in order to determine whether the second user is authorized to view the live resource shared by the first user. For example, decision 306 of method 300 includes determining, based on the sharing policies and the characteristics of the second user, whether the second user is authorized to view the live resource shared by the first user. In some approaches, the determination of whether the second user is authorized to view the live resource shared by the first user may be based on a comparison of the sharing policies and the characteristics of the second user. In some approaches, comparison techniques that would become apparent to one of ordinary skill in the art after reading the descriptions herein may be used to perform a comparison of the sharing policies and the characteristics of the second user. In some approaches, e.g., such as where the first user has a relatively high privacy mode, each of the sharing policies of the first user must be determined to be satisfied by the characteristics of the second user in order for a determination to be made that the second user is authorized to view the live resources shared by the first user. In some other approaches, e.g., such as where a relatively lower privacy mode is enabled by the first user, at least a predetermined number, e.g., a majority, at least half, 90%, etc., of the sharing policies of the first user must be determined to be satisfied by the characteristics of the second user in order for a determination to be made that the second user is authorized to view the live resources shared by the first user.

In response to a determination that the second user is authorized to view the live resource (e.g., as illustrated by the “Yes” logical path of decision 306), the second user is allowed to view the live resource, e.g., see operation 308. In some preferred approaches, the second user being allowed to view the live resource includes causing, e.g., instructing, a predetermined obfuscation condition to not be applied to the second user's view of the live resource. The predetermined obfuscation condition will be described in greater detail below, e.g., see operations 310-314.

In response to a determination that the second user is not authorized to view the live resource, a predetermined obfuscation condition is caused, e.g., instructed, output, etc., to be applied to the second user's view of the first user's live resource for protecting the first user's privacy. In other words, the predetermined obfuscation condition may be caused to be added to a feed of the metaverse received by a user device that the second user is using to interact in and view the metaverse. However, this predetermined obfuscation condition is caused to not be added to a feed of the metaverse received by a user device that a third user who is allowed to view the first user's live resource is using to interact in and view the metaverse.

The predetermined obfuscation condition that is applied preferably blocks and/or obscures the first user's live resource to at least some extent. It should be noted that the predetermined obfuscation condition that is applied in response to the determination that the second user is not authorized to view the live resource may depend on the approach. For example, in some preferred approaches, a type of privacy mode of the first user's sharing policies may be considered in order to determine the predetermined obfuscation condition to apply. In order to determine the predetermined obfuscation condition to apply to the second user's view of the first user's live resource, in some approaches, it is determined whether the sharing policies of the first user call for a relatively high privacy mode, e.g., see decision 310. In response to a determination that a relatively high privacy mode is enabled and/or a determination that the sharing policies call for a relatively high privacy mode (e.g., as illustrated by the “Yes” logical path of decision 310), in some approaches, a first predetermined obfuscation condition is caused to be applied to the second user's view of the live resource, e.g., see operation 312. In contrast, in response to a determination that a relatively high privacy mode is not enabled (e.g., as illustrated by the “No” logical path of decision 310), in some approaches, a second predetermined obfuscation condition is caused to be applied to the second user's view of the live resource, e.g., see operation 314. In some preferred approaches, the first predetermined obfuscation condition applies relatively more concealment of the first user's live resources than the second predetermined obfuscation condition. The first predetermined obfuscation condition may, in some approaches, obscure and/or mask contents of the first user's live resource, but the first user's live resource remains noticeable to some extent. For example, in one approach, the first predetermined obfuscation condition includes blurring the live resource, e.g., blurring words of the live resource, blurring video of the live resource, etc. As a result, a blurred version of the live content would be visible in the second user's feed of the metaverse. In another approach, the first predetermined obfuscation condition may additionally and/or alternatively include applying a predetermined static pattern over the live resource. For example, in some approaches, the predetermined pattern is defined by replacing content such as words of the live resource with other content that the first user has approved. This way, the second user may think that they are viewing the actual content of the first user's live resource, but in fact they may actually be viewing different content that the first user has preapproved and is comfortable with anyone viewing. In yet another approach, the first predetermined obfuscation condition may additionally and/or alternatively include visually redacting, e.g., marking out, distorting, etc., and/or removing a portion of contents of the live resource.

The predetermined obfuscation condition may, in some approaches, be applied to the live resources for a predetermined amount of time. For example, because the content of the live resources may change over time, e.g., based on what the first user decides to present and/or work on, the predetermined obfuscation condition may be applied to the live resources for a predetermined amount of time. This ensures that dynamic determinations are ongoingly performed to ensure that only users who are authorized to access content of the live resources are enabled to do so.

In some approaches, the first user may specify a context of the live resources that a predetermined obfuscation condition is to be applied to. In response to receiving keywords from an output feature for defining such context, method 300 may include applying a predetermined obfuscation condition to content of the live resources determined to match the context. For example, in some approaches, the first user may be a teacher, and the second user may be a student. While administering a test to the second user in the metaverse, techniques described herein enable the first user to continue to work on the live resources, while specifying that contents that would otherwise assist the second user in taking the test, e.g., answers, study materials, reading materials that the test is based on, etc., be visually redacted from the live resources.

While the first predetermined obfuscation condition may, in some approaches, obscure and/or mask contents of the first user's live resource while the first user's live resource remains noticeable to some extent, the second predetermined obfuscation condition may, in some approaches, prevent the first user's live resource from being noticeable within the metaverse. For example, in some approaches, an entirety of the first user's live resource may be removed from the second user's feed of the metaverse. In one or more of such approaches, this may be achieved where the first predetermined obfuscation condition includes a backdrop of the live resource being displayed on the live resource to thereby omit any appearance of the live resource to the second user. As a result of the first user's live resource appearing completely transparent, the first user interacting with the first user's live resource may appear as if the first user is viewing or working on something invisible and/or transparent.

Method 300, in some approaches, includes features for users to request access to live resources that the user is not otherwise authorized to access. For example, in some approaches, it may be determined whether a request for access has been received, e.g., see decision 316. In a more specific example, it may be determining that the second user is not authorized to view the live resource. Subsequent to causing the first predetermined obfuscation condition to be applied to the second user's view of the live resource in response to the determination that the second user is not authorized to view the live resource, a request to view the live resource may be received from a user device associated with the second user. The request for access may, in some approaches, be made by a user subsequent to a selectable feature for requesting such access being output to one or more user devices that are associated with users who are not granted full access to the live resources of the first user. In response to a determination that such a request for access has not been received, e.g., as illustrated by the “No” logical path of decision 316, the method 300 optionally ends, e.g., see “End”. In contrast, in response to a determination that such a request for access has been received, e.g., as illustrated by the “Yes” logical path of decision 316, a determination as to whether the sharing policies of the first user should be modified is performed, e.g., see decision 318. For example, selectable options may be output to the user device of the first user to request feedback as to whether the first user wants to modify the sharing policies to allow the second user access to the live resources.

In response to authorization to modify the sharing policies not being received, e.g., as illustrated by the “No” logical path of decision 318, the method optionally ends, e.g., see End. In contrast, subsequent to and in response to a determination that authorization to modify the sharing policies is received, the sharing policies may be modified, e.g. see operation 320. In some approaches, the sharing policies may be modified with respect to one or more characteristics that the second user who is requesting access to the live resources has. For example, in some approaches, one or more characteristics that the second user does not have, but that the sharing policies require, may be modified to thereby enable the second user to view at least some contents of the live resource. In some other approaches, the sharing policies may be modified only with respect to the requesting second user. These approaches prevent other users with similar characteristics to the second user from being granted access as a result of the modification. However, in some other approaches, the sharing policies may optionally be modified with respect to a plurality of users, e.g., all users, all requesting users, all users determined to be within a predetermined proximity of the live resources of the first user, etc.

Operation 322 includes updating the predetermined obfuscation condition in accordance with the modified sharing policies. It should be noted that, in some approaches, the modification may not result in the requesting second user being granted full access to the live resources of the first user. For example, in one approach, the sharing policies may be modified subsequent to receiving the request to view the live resource, and the modified sharing policies may specify that the characteristics of the second user authorize the second user to view the live resource. In order to update the predetermined obfuscation conditions in accordance with the modified sharing policies, method 300 may include a second predetermined obfuscation condition to be applied to the second user's view of the live resource where the second predetermined obfuscation condition enables the second user to view at least some contents of the live resource, e.g., relatively more than otherwise able to be viewed by the first user before the modification of the sharing policies.

Method 300 may additionally and/or alternatively include disabling a feature for user devices to request viewing of the live resource. For example, such a feature may be disabled in response to receiving a request from a user device to disable such a feature. Furthermore, such a feature may be disabled in response to a determination that the sharing policies call for a relatively high privacy mode.

Various benefits are enabled as a result of implementing the techniques described herein in a system that hosts and/or deploys a metaverse environment. For example, a considerable degree of privacy measures are enabled using the techniques described herein. As mentioned elsewhere above, privacy within conventional metaverse deployments is limited in that a user's live resources are often observable to other users. The techniques described herein enable various degrees of privacy that is based on sharing policies that users associated with the live resources are comfortable with. As a result, performance of user devices as well as hardware and software associated with deploying the metaverse improves, as eavesdropping users are prevented from maliciously exploiting the personal information of other users within the metaverse. More specifically, the relatively significant amount of computer processing and financial costs that are expended in recovering from successful unauthorized eavesdropping events, e.g., troubleshooting, implementing security measures, data recovery, etc., are mitigated as a result of implementing the techniques described herein. It should also be noted that use of selective obfuscation of live resources in a metaverse environment has heretofore not been considered in conventional metaverse applications and deployments. Accordingly, the inventive discoveries disclosed herein with regards to selective obfuscation of live resources in a metaverse environment proceed contrary to conventional wisdom.

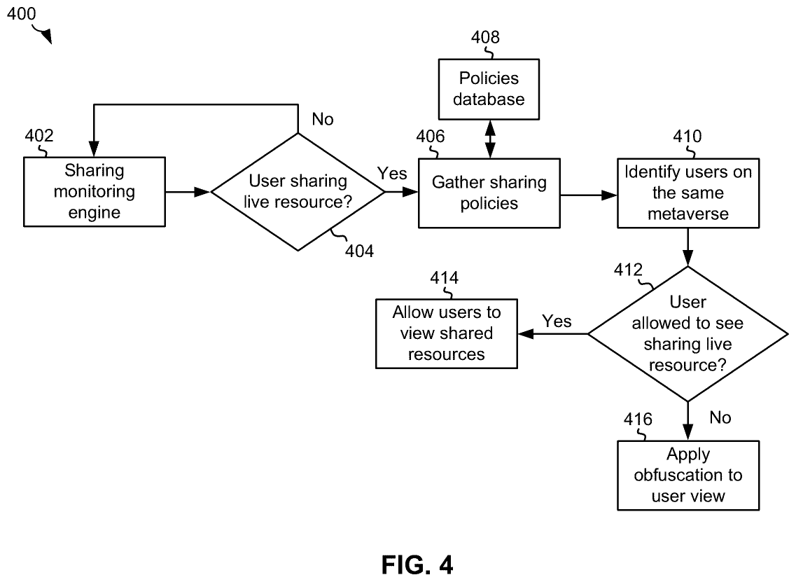

Now referring to FIG. 4, a flowchart of a method 400 is shown, according to one embodiment. The method 400 may be performed in accordance with the present invention in any of the environments depicted in any of the other FIGS., among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

Method 400 is performed using a computerized system, as the method 400 cannot practically be performed by a human, given the complexities of the calculations and sheer amount of data that is processed. Moreover, any attempt by a human to perform such method 400 would be expected to be rife with errors, again given the complexities of the calculations and sheer amount of data that is processed.

It may be prefaced that method 400 includes various operations for selective obfuscation of live resources in a metaverse environment. In some approaches, a sharing monitoring engine 402 may be used to determine whether a user, e.g., a first user, is sharing a live resource, e.g., see decision 404. In some approaches, the sharing monitoring engine may be of a type that would become apparent to one of ordinary skill in the art after reading the descriptions herein may be used. Furthermore, as indicated elsewhere herein, user monitoring and use of user data is preferably only performed subsequent to receiving unambiguously expressed permission from associated users.

In response to a determination that the first user is not sharing a live resource, e.g., as illustrated by the “No” logical path of decision 404, monitoring may continue. In contrast, in response to a determination that the first user is sharing a live resource, sharing policies of the first user may be gathered, e.g., see operation 406. In some approaches, the sharing policies are gathered from a predetermined policies database 408.

A determination may be made (e.g., see operation 410) as to whether users are within the same metaverse as the first user, e.g., a second user, a third user, etc. In some approaches, identification techniques that would become apparent to one of ordinary skill in the art after reading the descriptions herein may be used. Characteristics of users determined to be within the same metaverse may, in some approaches, be determined. Such characteristics may be used to determine whether other users are allowed to see, e.g., allowed access to view the live resource being shared by the first user, e.g., see decision 412. In some approaches, in response to a determination that a second user is allowed to see the live resource shared by the first user, e.g., as illustrated by the “Yes” logical path of decision 412, the second user is allowed to view the shared live resources of the first user, e.g., see operation 414. In contrast, in response to a determination that the second user is not authorized to view the live resource, e.g., as illustrated by the “No” logical path of decision 412, a first predetermined obfuscation condition is caused to be applied to the second user's view of the live resource for protecting the first user's privacy, e.g., see operation 416.

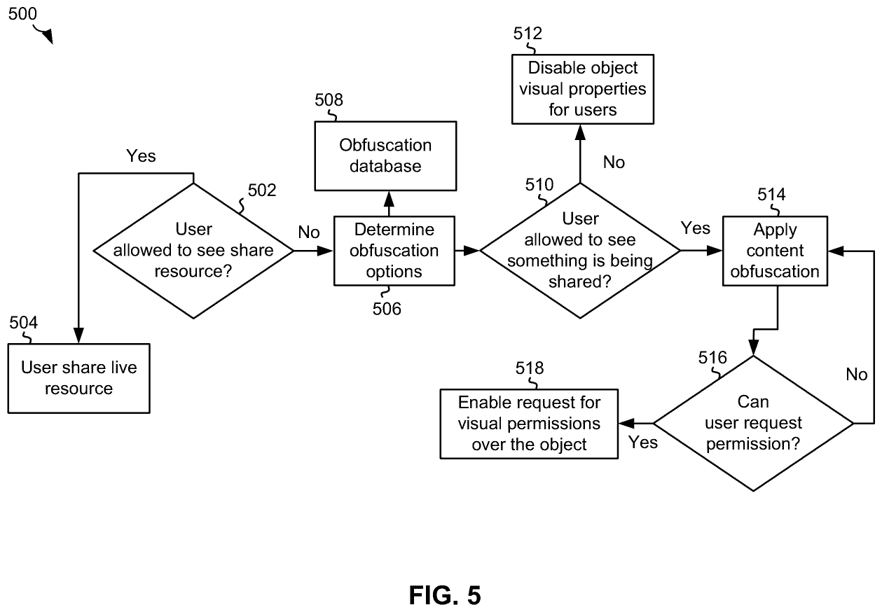

Now referring to FIG. 5, a flowchart of a method 500 is shown, according to one embodiment. The method 500 may be performed in accordance with the present invention in any of the environments depicted in any of the other FIGS., among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

Method 500 is performed using a computerized system, as the method 500 cannot practically be performed by a human, given the complexities of the calculations and sheer amount of data that is processed. Moreover, any attempt by a human to perform such method 500 would be expected to be rife with errors, again given the complexities of the calculations and sheer amount of data that is processed.

It may be prefaced that method 500 includes various operations for selective obfuscation of live resources in a metaverse environment. Decision 502 of method 500 includes determining whether a user is allowed, e.g., authorized, to see a shared live resource, e.g., whether a second user is authorized to view a live resource shared by a first user of a metaverse. In response to a determination that the second user is authorized to view the live resource shared by the first user, e.g., as illustrated by the “Yes” logical path of decision 502, the live resource is shared with the second user, e.g., see operation 504. In contrast, in response to a determination that the second user is not authorized to view the live resource shared by the first user, e.g., as illustrated by the “No” logical path of decision 502, a determination may be made as to which obfuscation option to apply to the live resource to protect the first user's privacy may be determined, e.g., see operation 506. In some approaches, the obfuscation option is determined from a predetermined obfuscation database, e.g., see operation 508.

In some approaches, a determination is made as to whether any portion of the live resource is allowed to be seen by a user, e.g., see decision 510. For example, in one or more of such approaches, a determination may be made whether the first user has a relatively high privacy mode enabled. In response to a determination that such a relatively high privacy mode is enabled, e.g., as illustrated by the “No” logical path of decision 510, object visual properties of the live resource may be disabled for the second user, e.g., see operation 512. In some approaches, disabling the object visual properties of the live resource may include causing a first predetermined obfuscation condition to be applied to the live resources where the first predetermined obfuscation condition includes a backdrop of the live resource being displayed on the live resource. This then omits any appearance of the live resource to the second user and thereby causes an area of the metaverse that would otherwise include the live resource to appear as if the first user is viewing or working on something invisible and/or transparent. In contrast, in response to a determination that the first user does not have a relatively high privacy mode enabled, e.g., as illustrated by the “Yes” logical path of decision 510, a predetermined obfuscation condition for applying to the live resource of the first user may be determined, e.g., see operation 514.

Decision 516 includes determining whether a user can request permission to view live resources. For example, a determination may be made as to whether the second user who is currently viewing obfuscated live resources of the first user, can request permission to view the live resources without the obfuscation. In some approaches, in response to a determination that the first user has a relatively high privacy mode activated, the second user is not allowed to request permission to view the live resources without the obfuscation, e.g., see the “No” logical path of decision 516. In contrast, in some approaches, in response to a determination that the first user does not have a relatively high privacy mode activated, the second user is allowed to request permission to view the live resources without the obfuscation, e.g., see the “Yes” logical path of decision 516 continue to operation 518.

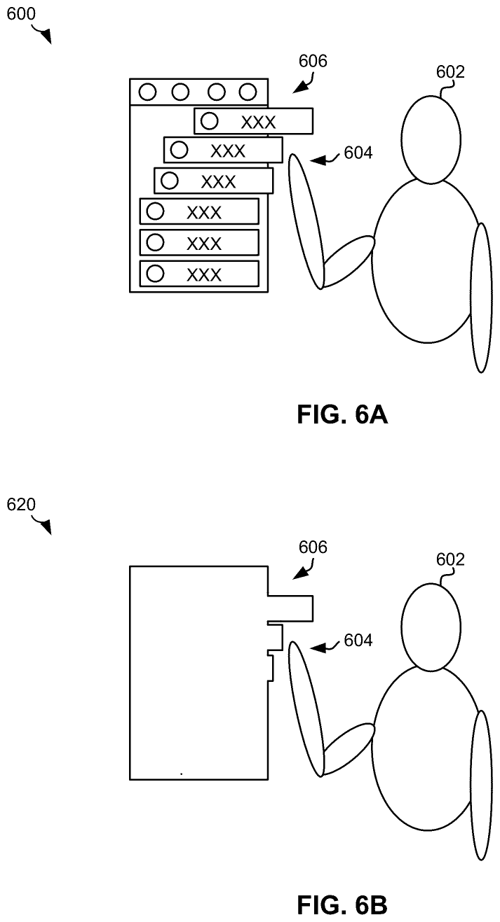

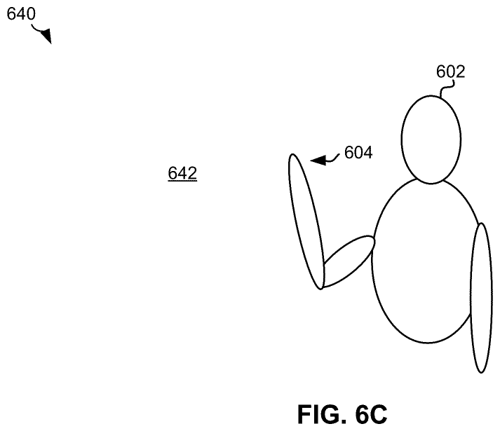

FIGS. 6A-6C depict representations 600, 620 and 640, in accordance with several embodiments. As an option, the present representations 600, 620 and 640 may be implemented in conjunction with features from any other embodiment listed herein, such as those described with reference to the other FIGS. Of course, however, such representations 600, 620 and 640 and others presented herein may be used in various applications and/or in permutations which may or may not be specifically described in the illustrative embodiments listed herein. Further, the representations 600, 620 and 640 presented herein may be used in any desired environment.

Referring first to FIG. 6A, the representation 600 includes a first user's avatar 602 of a metaverse that is sharing live resources. For example, a virtual display 606 is floating in front of the first user's avatar and is being actively navigated by a hand 604 of the first user's avatar, e.g., navigating among different messages of a messaging application displayed on the virtual display 606. It should be noted that in representation 600, a predetermined obfuscation condition is not being applied to a second user's view of the live resource, e.g., a view shown in FIG. 6A. In contrast, in the representation 620 of FIG. 6B, a first predetermined obfuscation condition is being applied to the second user's view of the live resource. For example, the first predetermined obfuscation condition includes contents of the live resource being visually redacted, e.g., “whited-out”. It should be noted that at least a portion of the live resource is still visible in the second user's view of the live resource, e.g., see contour of the virtual display.

Referring now to representation 640 of FIG. 6C, a second predetermined obfuscation condition is being applied to the second user's view of the live resource. For example, the second predetermined obfuscation condition includes a backdrop of the live resource being displayed on the live resource to thereby omit any appearance of the live resource to the second user. In other words, where the live resource would otherwise be visible, e.g., see location 642, visible obfuscation techniques are removed over the live resource so that it appears as if the first user is viewing or working on something invisible and/or transparent.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
gathering sharing policies associated with a first user sharing a live resource in a metaverse;
determining characteristics of a second user in the metaverse;
determining, based on the sharing policies and the characteristics of the second user, whether the second user is authorized to view the live resource shared by the first user;
in response to a determination that the second user is not authorized to view the live resource, causing a first predetermined obfuscation condition to be applied to the second user's view of the live resource for protecting the first user's privacy; and
in response to a determination that the second user is authorized to view the live resource, allowing the second user to view the live resource.

2. The computer-implemented method of claim 1, wherein the first predetermined obfuscation condition is selected from the group consisting of: blurring the live resource, applying a predetermined static pattern over the live resource, and visually redacting a portion of contents of the live resource.

3. The computer-implemented method of claim 1, wherein the first predetermined obfuscation condition includes a backdrop of the live resource being displayed on the live resource to thereby omit any appearance of the live resource to the second user.

4. The computer-implemented method of claim 3, wherein the first predetermined obfuscation condition is caused to be applied to the second user's view of the live resource in response to a determination that the sharing policies call for a relatively high privacy mode.

5. The computer-implemented method of claim 4, comprising: disabling a feature for user devices to request viewing of the live resource in response to a determination that the sharing policies call for a relatively high privacy mode.

6. The computer-implemented method of claim 1, comprising: determining that the second user is not authorized to view the live resource; and subsequent to causing the first predetermined obfuscation condition to be applied to the second user's view of the live resource in response to the determination that the second user is not authorized to view the live resource, receiving, from a user device associated with the second user, a request to view the live resource.

7. The computer-implemented method of claim 5, comprising: modifying the sharing policies subsequent to receiving the request to view the live resource, wherein the modified sharing policies specify that the characteristics of the second user authorize the second user to view the live resource; and causing a second predetermined obfuscation condition to be applied to the second user's view of the live resource, wherein the second predetermined obfuscation condition enables the second user to view at least some contents of the live resource.

8. The computer-implemented method of claim 1, wherein the live resource is selected from the group consisting of: a camera feed, a shared screen, and an audio feed paired with a visual display.

9. The computer-implemented method of claim 8, wherein the live resource is configured to be interacted with by an avatar associated with at least the first user who exists in the metaverse.

10. A computer program product, the computer program product comprising a computer readable storage medium having program instructions embodied therewith, the program instructions executable by a computer to cause the computer to:
gather sharing policies associated with a first user sharing a live resource in a metaverse;
determine characteristics of a second user in the metaverse;
determine, based on the sharing policies and the characteristics of the second user, whether the second user is authorized to view the live resource shared by the first user;
in response to a determination that the second user is not authorized to view the live resource, cause a first predetermined obfuscation condition to be applied to the second user's view of the live resource for protecting the first user's privacy; and
in response to a determination that the second user is authorized to view the live resource, allow the second user to view the live resource.

11. The computer program product of claim 10, wherein the first predetermined obfuscation condition is selected from the group consisting of: blurring the live resource, applying a predetermined static pattern over the live resource, and visually redacting a portion of contents of the live resource.

12. The computer program product of claim 10, wherein the first predetermined obfuscation condition includes a backdrop of the live resource being displayed on the live resource to thereby omit any appearance of the live resource to the second user.

13. The computer program product of claim 12, wherein the first predetermined obfuscation condition is caused to be applied to the second user's view of the live resource in response to a determination that the sharing policies call for a relatively high privacy mode.

14. The computer program product of claim 13, the program instructions executable by the computer to cause the computer to: disable a feature for user devices to request viewing of the live resource in response to a determination that the sharing policies call for a relatively high privacy mode.

15. The computer program product of claim 10, the program instructions executable by the computer to cause the computer to: determine that the second user is not authorized to view the live resource; and subsequent to causing the first predetermined obfuscation condition to be applied to the second user's view of the live resource in response to the determination that the second user is not authorized to view the live resource, receive, from a user device associated with the second user, a request to view the live resource.

16. The computer program product of claim 15, the program instructions executable by the computer to cause the computer to: modify the sharing policies subsequent to receiving the request to view the live resource, wherein the modified sharing policies specify that the characteristics of the second user authorize the second user to view the live resource; and cause a second predetermined obfuscation condition to be applied to the second user's view of the live resource, wherein the second predetermined obfuscation condition enables the second user to view at least some contents of the live resource.

17. The computer program product of claim 10, wherein the live resource is selected from the group consisting of: a camera feed, a shared screen, and an audio feed paired with a visual display.

18. The computer program product of claim 17, wherein the live resource is configured to be interacted with by an avatar associated with at least the first user who exists in the metaverse.

19. A system, comprising:
a hardware processor; and
logic integrated with the processor, executable by the processor, or integrated with and executable by the processor, the logic being configured to:
gather sharing policies associated with a first user sharing a live resource in a metaverse;
determine characteristics of a second user in the metaverse;
determine, based on the sharing policies and the characteristics of the second user, whether the second user in the metaverse is authorized to view the live resource shared by the first user;
in response to a determination that the second user is not authorized to view the live resource, cause a first predetermined obfuscation condition to be applied to the second user's view of the live resource for protecting the first user's privacy; and
in response to a determination that the second user is authorized to view the live resource, allow the second user to view the live resource.

20. The system of claim 19, wherein the first predetermined obfuscation condition is selected from the group consisting of: blurring the live resource, applying a predetermined static pattern over the live resource, and visually redacting a portion of contents of the live resource.
